(19) United States
(12) Patent Application Publication
(10) Pub. No.: US 2025/0084345 A1
(43) Pub. Date: Mar. 13, 2025

(54) FABRIC CARE COMPOSITION

(71) Applicants: Dow Global Technologies LLC, Midland, MI (US); Dow Silicones Corporation, Midland, MI (US); Rohm and Haas Company, Collegeville, PA (US)

(72) Inventors: Randara Pulukkody, Lansdale, PA (US); Michelle Sikarskie, Midland, MI (US); Lyndsay M. Leal, Spring City, PA (US); Paula Bauer, Freeland, MI (US); Emmett M. Partain, III, Bound Brook, NJ (US)

(21) Appl. No.: 18/728,475

(22) PCT Filed: Jan. 19, 2023
(86) PCT No.: PCT/US2023/011096

§ 371 Date: Jul. 12, 2024

Related U.S. Application Data
(60) Provisional application No. 63/304,001, filed on Jan. 28, 2022.

(51) Int. Cl. C11D 3/22; C11D 1/22; C11D 1/29; C11D 1/72; C11D 1/83; C11D 3/00; C11D 3/37

(52) U.S. Cl. CPC C11D 3/227; C11D 1/83; C11D 3/0015; C11D 3/373; C11D 1/22; C11D 1/29; C11D 1/72

(57) ABSTRACT

A fabric care composition is provided including water; a cleaning surfactant; a fabric softening silicone, wherein the fabric softening silicone is a nitrogen containing silicone; and a deposition aid polymer, wherein the deposition aid polymer is a dextran polymer functionalized with quaternary ammonium moieties; and wherein the deposition aid polymer enhances deposition of the fabric softening silicone from the fabric care composition onto a fabric.

The present invention relates to a fabric care composition. In particular, the present invention relates to a fabric care composition including water; a cleaning surfactant; a fabric softening silicone, wherein the fabric softening silicone is a nitrogen containing silicone; and a deposition aid polymer, wherein the deposition aid polymer is a dextran polymer functionalized with quaternary ammonium moieties; wherein the deposition aid polymer enhances deposition of the fabric softening silicone from the fabric care composition onto a fabric.

Use of cationic carbohydrate polymers in laundry detergents is known, as in, e.g., U.S. Pat. No. 6,833,347. However, this reference does not suggest the use of the modified polymers described herein.

A modified carbohydrate polymer having quaternary ammonium groups has been disclosed for use in fabric care by Eldredge, et al. in U.S. Patent Application Publication No. 20170335242. Eldredge, et al disclose a fabric care composition comprising a modified carbohydrate polymer having quaternary ammonium groups having at least one C₈₋₂₂ alkyl or alkenyl group; wherein the modified carbohydrate polymer has a weight-average molecular weight of at least 500,000; and wherein at least 20 wt % of the quaternary ammonium groups on the at least one modified carbohydrate polymer have at least one C₈₋₂₂ alkyl or alkenyl group.

A fabric care composition is disclosed by Pulukkody et al. in WO 2021/194808. Pulukkody et al. disclose a fabric care composition comprising: water; a cleaning surfactant; a fabric softening silicone; and a deposition aid polymer, wherein the deposition aid polymer is a dextran polymer functionalized with quaternary ammonium moieties; and wherein the deposition aid polymer enhances deposition of the fabric softening silicone from the fabric care composition onto a fabric.

Notwithstanding, there remains a continuing need for fabric care compositions having a desirable balance of performance properties, particularly softening and anti-redeposition; particularly formulations using nitrogen containing fabric softening silicones.

The present invention provides a fabric care composition comprising: water; a cleaning surfactant; a fabric softening silicone, wherein the fabric softening silicone is a nitrogen containing silicone; and a deposition aid polymer, wherein the deposition aid polymer is a dextran polymer functionalized with quaternary ammonium moieties; and wherein the deposition aid polymer enhances deposition of the fabric softening silicone from the fabric care composition onto a fabric.

The present invention provides a method of treating an article of laundry, comprising: providing an article of laundry; selecting a fabric care composition according to the present invention; providing a bath water; and applying the bath water and the fabric care composition to the article of laundry to provide a treated article of laundry; wherein the fabric softening silicone is associated with the treated article of laundry.

### DETAILED DESCRIPTION

It has been found that a fabric care composition including a nitrogen containing fabric softening silicone in combination with a deposition aid polymer comprising a dextran polymer functionalized with quaternary ammonium moieties provides a surprisingly favorable balance of softening and anti-redeposition.

Unless otherwise indicated, ratios, percentages, parts, and the like are by weight. Weight percentages (or wt %) in the composition are percentages of dry weight, i.e., excluding any water that may be present in the composition.

As used herein, unless otherwise indicated, the terms “weight average molecular weight” and “Mw” are used interchangeably to refer to the weight average molecular weight as measured in a conventional manner with gel permeation chromatography (GPC) and conventional standards, such as polyethylene glycol standards. GPC techniques are discussed in detail in Modem Size Exclusion Chromatography, W. W. Yau, J. J. Kirkland, D. D. Bly; Wiley-Interscience, 1979, and in A Guide to Materials Characterization and Chemical Analysis, J. P. Sibilia; VCH, 1988, p. 81-84. Weight average molecular weights are reported herein in units of Daltons.

Preferably, the fabric care composition of the present invention, comprises: water (preferably, 10 to 94.9 wt % (more preferably, 25 to 94 wt %; still more preferably, 40 to 85 wt %; most preferably, 50 to 75 wt %), based on the weight of the fabric care composition, of water); a cleaning surfactant (preferably, 5 to 89.9 wt % (more preferably, 7.5 to 75 wt %; still more preferably, 10 to 60 wt %; most preferably, 15 to 30 wt %), based on the weight of the fabric care composition, of the cleaning surfactant); a fabric softening silicone (preferably, 0.05 to 10 wt % (more preferably, 0.1 to 5 wt %; most preferably, 0.1 to 3.5 wt %), based on the weight of the fabric care composition, of the fabric softening silicone), wherein the fabric softening silicone is a nitrogen containing silicone; and a deposition aid polymer (preferably, 0.05 to 5.0 wt %; more preferably, 0.075 to 3.0 wt %; still more preferably, 0.09 to 2.5 wt %; most preferably, 0.1 to 2.25 wt %), based on the weight of the fabric care composition, of the deposition aid polymer), wherein the deposition aid polymer is a dextran polymer (preferably, a branched chain dextran polymer) functionalized with quaternary ammonium moieties (preferably, wherein the deposition aid polymer has a Kjeldahl nitrogen content corrected for ash and volatiles, TKN, of ≥0.5 wt % (preferably, 0.5 to 5.0 wt %; more preferably, 0.5 to 4.0 wt %; still more preferably, 0.75 to 2.5 wt %; most preferably, 1 to 2 wt %); wherein the deposition aid polymer enhances deposition of the fabric softening silicone from the fabric care composition onto a fabric (preferably, wherein the fabric is selected from the group consisting of cotton interlock, cotton, poly cotton blend and cotton terry; more preferably, wherein the fabric contains cotton; most preferably, wherein the fabric is cotton).

Preferably, the fabric care composition of the present invention is a liquid formulation. More preferably, the fabric care composition of the present invention is an aqueous liquid formulation.

Preferably, the fabric care composition of the present invention, comprises: water. More preferably, the fabric care composition of the present invention, comprises: 10 to 94.9 wt % (more preferably, 25 to 94 wt %; still more preferably, 40 to 85 wt %; most preferably, 50 to 75 wt %), based on the weight of the fabric care composition, of water. Still more preferable, the fabric care composition of the present invention, comprises: 10 to 94.9 wt % (more preferably, 25 to 94 wt %; still more preferably, 40 to 85 wt %; most preferably, 50 to 75 wt %), based on the weight of the fabric care composition, of water, wherein the water is at least one of distilled water and deionized water. Most preferably, the fabric care composition of the present invention, comprises: 10 to 94.9 wt % (more preferably, 25 to 94 wt %; still more preferably, 40 to 85 wt %; most preferably, 50 to 75 wt %), based on the weight of the fabric care composition, of water, wherein the water is distilled and deionized.

Preferably, the fabric care composition of the present invention, comprises: a cleaning surfactant. More preferably, the fabric care composition of the present invention, comprises: 5 to 89.9 wt % (preferably, 7.5 to 75 wt %; more preferably, 10 to 60 wt %; most preferably, 15 to 30 wt %), based on the weight of the fabric care composition, of a cleaning surfactant. Still more preferably, the fabric care composition of the present invention, comprises: 5 to 89.9 wt % (preferably, 7.5 to 75 wt %; more preferably, 10 to 60 wt %; most preferably, 15 to 30 wt %), based on the weight of the fabric care composition, of a cleaning surfactant; wherein the cleaning surfactant is selected from the group consisting of anionic surfactants, nonionic surfactants, cationic surfactants, amphoteric surfactants and mixtures thereof. Yet still more preferably, the fabric care composition of the present invention, comprises: 5 to 89.9 wt % (preferably, 7.5 to 75 wt %; more preferably, 10 to 60 wt %; most preferably, 15 to 30 wt %), based on the weight of the fabric care composition, of a cleaning surfactant; wherein the cleaning surfactant is selected from the group consisting of a mixture including an anionic surfactant and a non-ionic surfactant. Most preferably, the fabric care composition of the present invention, comprises: 5 to 89.9 wt % (preferably, 7.5 to 75 wt %; more preferably, 10 to 60 wt %; most preferably, 15 to 30 wt %), based on the weight of the fabric care composition, of a cleaning surfactant; wherein the cleaning surfactant includes a mixture of a linear alkyl benzene sulfonate, a sodium lauryl ethoxysulfate and a nonionic alcohol ethoxylate.

Anionic surfactants include alkyl sulfates, alkyl benzene sulfates, alkyl benzene sulfonic acids, alkyl benzene sulfonates, alkyl polyethoxy sulfates, alkoxylated alcohols, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenols, alkyl phenol polyethoxy ether sulfates, 2-acryloxy-alkane-1-sulfonic acid, 2-acryloxy-alkane-1-sulfonate, beta-alkyloxy alkane sulfonic acid, beta-alkyloxy alkane sulfonate, amine oxides and mixtures thereof. Preferred anionic surfactants include C₈₋₂₀ alkyl benzene sulfates, C₈₋₂₀ alkyl benzene sulfonic acid, C₈₋₂₀ alkyl benzene sulfonate, paraffin sulfonic acid, paraffin sulfonate, alpha-olefin sulfonic acid, alpha-olefin sulfonate, alkoxylated alcohols, C₈₋₂₀ alkyl phenols, amine oxides, sulfonates of fatty acids, sulfonates of fatty acid esters and mixtures thereof. More preferred anionic surfactants include C₁₂₋₁₆ alkyl benzene sulfonic acid, C₁₂₋₁₆ alkyl benzene sulfonate, C₁₂₋₁₈ paraffin-sulfonic acid, C₁₂₋₁₈ paraffin-sulfonate and mixtures thereof.

Non-ionic surfactants include secondary alcohol ethoxylates, ethoxylated 2-ethylhexanol, ethoxylated seed oils, butanol caped ethoxylated 2-ethylhexanol and mixtures thereof. Preferred non-ionic surfactants include secondary alcohol ethoxylates.

Cationic surfactants include quaternary surface active compounds. Preferred cationic surfactants include quaternary surface active compounds having at least one of an ammonium group, a sulfonium group, a phosphonium group, an iodinium group and an arsonium group. More preferred cationic surfactants include at least one of a dialkyldimethylammonium chloride and alkyl dimethyl benzyl ammonium chloride. Still more preferred cationic surfactants include at least one of C₁₆₋₁₈ dialkyldimethylammonium chloride, a C₈₋₁₈ alkyl dimethyl benzyl ammonium chloride di-tallow dimethyl ammonium chloride and di-tallow dimethyl ammonium chloride. Most preferred cationic surfactant includes di-tallow dimethyl ammonium chloride.

Amphoteric surfactants include betaines, amine oxides, alkylamidoalkylamines, alkyl-substituted amine oxides, acylated amino acids, derivatives of aliphatic quaternary ammonium compounds and mixtures thereof. Preferred amphoteric surfactants include derivatives of aliphatic quaternary ammonium compounds. More preferred amphoteric surfactants include derivatives of aliphatic quaternary ammonium compounds with a long chain group having 8 to 18 carbon atoms. Still more preferred amphoteric surfactants include at least one of C₁₂₋₁₄ alkyldimethylamine oxide, 3-(N,N-dimethyl-N-hexadecyl-ammonio)propane-1-sulfonate, 3-(N,N-dimethyl-N-hexadecylammonio)-2-hydroxypropane-1-sulfonate. Most preferred amphoteric surfactants include at least one of C₁₂₋₁₄ alkyldimethylamine oxide.

Preferably, the fabric care composition of the present invention, comprises: 0.05 to 10 wt % (preferably, 0.1 to 5 wt %; more preferably, 0.1 to 3.5 wt %), based on the weight of the fabric care composition, of a fabric softening silicone, wherein the fabric softening silicone is a nitrogen containing silicone. More preferably, the fabric care composition of the present invention, comprises: 0.05 to 10 wt % (preferably, 0.1 to 5 wt %; more preferably, 0.1 to 3.5 wt %), based on the weight of the fabric care composition, of a fabric softening silicone, wherein the fabric softening silicone is a nitrogen containing silicone having formula selected from the group consisting of formula (a) and formula (b)

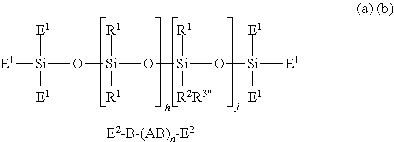

and
wherein each E¹ is independently selected from the group consisting of a monovalent hydrocarbon group, a hydroxyl group, and an alkoxy group; each R¹ is independently a monovalent hydrocarbon group; each R² is independently a divalent hydrocarbon group having 1 to 10 carbon atoms; h is 25 to 1,000; and j is 0.1 to 200. Each R^{3″} is generally a —NR^{4″} or a heterocyclic nitrogen-containing compound, which may be, e.g.,

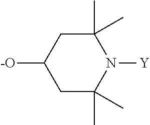

wherein each R^{4″} is independently selected from the group consisting of a hydrogen atom and a group of formula —R²NY₂, each Y is independently a hydrogen atom or Y′, and each Y′ is a group of the formula

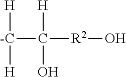

wherein R², which can be the same or different, is characterized as above, and with the proviso that every Y is not H; wherein each E² is an organofunctional endblocking group; wherein A is a divalent organic group comprising at least one polyether group; wherein B is a diorganopolysiloxane; and wherein n is at least 1 (preferably, 1 to 50). Most preferably, the fabric care composition of the present invention, comprises: 0.05 to 10 wt % (preferably, 0.1 to 5 wt %; more preferably, 0.1 to 3.5 wt %), based on the weight of the fabric care composition, of a fabric softening silicone, wherein the fabric softening silicone is a nitrogen containing silicone having formula (a).

Preferably, each E¹ is an endblocking group independently selected from the group consisting of monovalent hydrocarbon groups, hydroxyl groups, and alkoxy groups. More preferably, each E¹ is an endblocking group independently selected from the group consisting of alkyl groups (e.g., methyl, ethyl, propyl, butyl, pentyl and hexyl); aryl groups (e.g., phenyl, tolyl and xylyl) and aralkyl groups (e.g., benzyl and phenethyl). When the endblocking group E¹ is an alkoxy group, it preferably has 1 to 15 carbon atoms. Alkyl groups are most preferred, and methyl is particularly preferred.

Preferably, each R² is independently a divalent hydrocarbon group of 1 to 10 carbon atoms. The divalent groups are exemplified by alkylene groups such as ethylene, propylene, butylene, isobutylene, and methylpropylene; and alkylene-arylene groups expressed by the formula

—(CH₂)₂—C₆H₄.

Alkylene groups such as ethylene, propylene, and isobutylene are preferred.

Preferably, each R¹ is an alkyl group such as methyl, R² is an alkylene group such as isobutyl, h is 75 to 400 and j is 0.75 to 20.

Preferably, Y′ is:

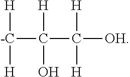

Preferably, R^{4″} is selected from:

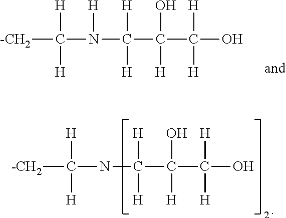

Preferably, the organofunctional endblocking group E² in the nitrogen silicone of formula (b) has formula R^{A}CH₂CH(OH)CH₂OR⁹—; wherein R^{A} is a monovalent amine functional group and R⁹ is a divalent hydrocarbon linking group containing 2 to 6 carbon atoms (e.g., divalent alkylene, such as, ethylene, propylene, butylene, isobutylene, pentylene and hexylene). Typically, R⁹ is propylene —CH₂CH₂CH₂—. The monovalent amine functional group R^{A} may be any amine functional organic group. The nitrogen atom of the amine functional group is bonded to the methylene group of the —CH₂CH(OH)CH₂OR⁹— end blocking group. The amine functional group may be any secondary, tertiary or quaternary amine, but typically are tertiary amines. The amine functional group may include other organic functional groups, such as amino, hydroxy, epoxy, ether, amido, and carboxyl groups. Thus, R^{A} may have the formula —N(R¹⁰)₂, —N(H)(R¹⁰), —N(R¹⁰)₃; wherein R¹⁰ is independently a monovalent organic containing 1 to 30 carbon atoms (preferably, wherein R¹⁰ is independently selected from the group consisting of methyl, ethyl, propyl and butyl). Preferably, R^{A} is selected from the group consisting of —N(H)(CH₃), —N(CH₃)₂, —N(H)(CH₂CH₃), —N(CH₂CH₃)₂, —N(CH₂CH₃)₃ and —N(CH₂CH₂OH)₂. The amine functional group may include cyclic amines such as pyrrolidine; piperidine; morpholine; 3-pyrrolidinol; 2,5-dimethylpyrrolidine; 1-methylpiperazine; 2,6-imethylpiperidine; 1-ethylpiperazine; 1-amino-4-methylpiperazine and isoindoline.

Preferably, the divalent organic group A in the nitrogen containing silicone of formula (b), comprises at least one polyether group. As used herein, “polyether” designates a polyoxyalkylene group. The polyoxyalkylene group may be represented by the formula (CᵢH₂ᵢO)ᵣ, wherein i is 2 to 4 and r is at least 4 (preferably, 5 to 60; more preferably, 5 to 30). The polyoxyalkylene group may comprise oxyethylene units (C₂H₄O), oxypropylene units (C₃H₆O), oxybutylene units (C₄H₈O), or mixtures thereof. Typically, the polyoxyalkylene group comprises oxyethylene units (C₂H₄O) or mixtures of oxyethylene units and oxypropylene units.

The diorganopolysiloxane group B in the nitrogen containing silicone of formula (b), may be a predominately linear siloxane polymer having the formula (R¹¹SiO)ₜ, wherein R¹¹ is independently selected from a monovalent hydrocarbon group and a monovalent halogenated hydrocarbon group; and t is at least 1 (preferably, 2 to 100; more preferably, 2 to 50). The monovalent hydrocarbon groups represented by R¹¹ are preferably free of aliphatic unsaturation and have 1 to 30 carbon atoms (preferably, 1 to 10 carbon atoms). The monovalent hydrocarbon groups represented by R¹¹ are exemplified by alkyl groups (e.g., methyl, ethyl, propyl, butyl, pentyl, hexyl, heptyl, octyl, undecyl and octadecyl); cycloalkyl groups (e.g., cyclohexyl); aryl groups (e.g., phenyl, tolyl, xylyl, benzyl and w-phenylethyl); and halogenated hydrocarbon groups (e.g., 3,3,3-trifluoropropyl, 3-chloropropyl and dichlorophenyl).

Representative, non-limiting average formulas of the nitrogen containing fabric softening silicone having formula (b) include

Et₂NCH₂CH(OH)CH₂O(CH₂)₃(Me₂SiO)ₙMe₂Si—[[(CH₂)₃(EO)_{m′}(CH₂)₃][(Me₂SiO)ₙMe₂Si]]ₚ—(CH₂)₃OCH₂CH(OH)CH₂NEt₂

Et₂NCH₂CH(OH)CH₂O(CH₂)₃(Me₂SiO)ₙMe₂Si—[[(CH₂)₃[(EO)_{m′}(PO)_{m″}](CH₂)₃][(Me₂SiO)ₙMe₂Si]]ₚ—(CH₂)₃OCH₂CH(OH)CH₂NEt₂

Et₂NCH₂CH(OH)CH₂O(CH₂)₃(Me₂SiO)ₙMe₂Si—[[CH₂CH(Me)CH₂[(EO)_{m′}]CH₂CH(Me)CH₂][(Me₂SiO)ₙMe₂Si]]ₚ—(CH₂)₃OCH₂CH(OH)CH₂NEt₂

Et₂NCH₂CH(OH)CH₂O(CH₂)₃(Me₂SiO)ₙMe₂Si—[[CH₂CH(Me)CH₂[(EO)_{m′}(PO)_{m″}]CH₂CH(Me)CH₂][(Me₂SiO)ₙMe₂Si]]ₚ—(CH₂)₃OCH₂CH(OH)CH₂NEt₂

wherein n is at least 1 (preferably, 1 to 50); wherein p is ≥0; wherein m′ is ≥0 (preferably, 0 to 60); wherein m″ is ≥0 (preferably, 0 to 60); with the proviso that m′+m″≥4; wherein Me is methyl; wherein Et is ethyl; wherein EO is CH₂CH₂O; wherein PO is CH₂CH(Me)O or CH₂CH₂CH₂O.

Preferably, the fabric care composition of the present invention, comprises: 0.05 to 10 wt % (preferably, 0.1 to 5 wt %; more preferably, 0.1 to 3.5 wt %), based on the weight of the fabric care composition, of a fabric softening silicone, wherein the fabric softening silicone is a nitrogen containing silicone; wherein the nitrogen containing silicone contains 0.1 to 2 wt % (preferably, 0.15 to 1.5 wt %; more preferably, 0.18 to 1.25 wt %; most preferably, 0.2 to 1 wt %) nitrogen.

Preferably, the fabric care composition of the present invention comprises a deposition aid polymer; wherein the deposition aid polymer is a dextran polymer functionalized with quaternary ammonium moieties; wherein the deposition aid polymer enhances deposition of silicone from the fabric care composition onto a fabric (preferably, a cotton fabric). More preferably, the fabric care composition of the present invention comprises 0.05 to 5.0 wt % (preferably, 0.075 to 3.0 wt %; more preferably, 0.09 to 2.5 wt %; most preferably, 0.1 to 2.25 wt %), based on the weight of the fabric care composition, of a deposition aid polymer; wherein the deposition aid polymer is a dextran polymer functionalized with quaternary ammonium moieties; wherein the deposition aid polymer enhances deposition of silicone from the fabric care composition onto a fabric (preferably, a cotton fabric). Most preferably, the fabric care composition of the present invention comprises 0.05 to 5.0 wt % (preferably, 0.075 to 3.0 wt %; more preferably, 0.09 to 2.5 wt %; most preferably, 0.1 to 2.25 wt %), based on the weight of the fabric care composition, of a deposition aid polymer; wherein the deposition aid polymer is a dextran polymer functionalized with quaternary ammonium moieties; wherein the deposition aid polymer enhances deposition of silicone from the fabric care composition onto a fabric (preferably, a cotton fabric); wherein the deposition aid polymer has a Kjeldahl nitrogen content corrected for ash and volatiles, TKN, of ≥0.5 wt % (preferably, 0.5 to 5.0 wt %; more preferably, 0.5 to 4.0 wt %; still more preferably, 0.75 to 2.5 wt %; most preferably, 1 to 2 wt %) (measured using a Buchi KjelMaster K-375 automated analyzer, corrected for volatiles and ash measured as described in ASTM method D-2364); wherein the deposition aid polymer enhances deposition of silicone from the fabric care composition onto a fabric (preferably, a cotton fabric).

Preferably, the deposition aid polymer is a dextran polymer functionalized with quaternary ammonium moieties. More preferably, the deposition aid polymer is a dextran polymer functionalized with quaternary ammonium moieties; wherein the dextran polymer is a branched chain dextran polymer. Still more preferably, the deposition aid polymer is a dextran polymer functionalized with quaternary ammonium moieties; wherein the dextran polymer comprises a branched chain dextran polymer; wherein the branched chain dextran polymer comprises a plurality of glucose structural units; wherein 90 to 98 mol % (preferably, 92.5 to 97.5 mol %; more preferably, 93 to 97 mol %; most preferably, 94 to 96 mol %) of the glucose structural units are connected by α-D-1,6 linkages and 2 to 10 mol % (preferably, 2.5 to 7.5 mol %; more preferably, 3 to 7 mol %; most preferably, 4 to 6 mol %) of the glucose structural units are connected by α-1,3 linkages. Most preferably, the deposition aid polymer is a dextran polymer functionalized with quaternary ammonium moieties; wherein the dextran polymer is a branched chain dextran polymer; wherein the branched chain dextran polymer comprises a plurality of glucose structural units; wherein 90 to 98 mol % (preferably, 92.5 to 97.5 mol %; more preferably, 93 to 97 mol %; most preferably, 94 to 96 mol %) of the glucose structural units are connected by α-D-1,6 linkages and 2 to 10 mol % (preferably, 2.5 to 7.5 mol %; more preferably, 3 to 7 mol %; most preferably, 4 to 6 mol %) of the glucose structural units are connected by α-1,3 linkages according to formula (I)

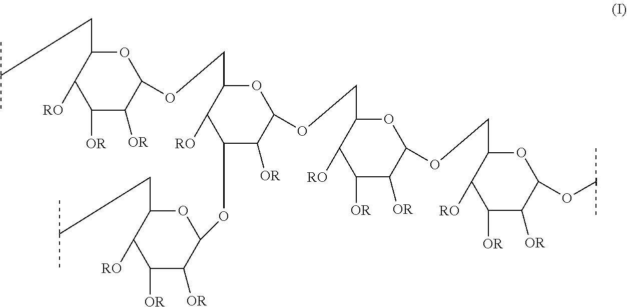

wherein R is selected from a hydrogen, a C₁₋₄ alkyl group and a hydroxy C₁₋₄ alkyl group; and wherein the average branch off the dextran polymer backbone is ≤3 anhydroglucose units.

Preferably, the dextran polymer contains less than 0.01 wt %, based on weight of the dextran polymer, of alternan. More preferably, the dextran polymer contains less than 0.001 wt %, based on weight of the dextran polymer, of alternan. Most preferably, the dextran polymer contains less than the detectable limit of alternan.

Preferably, the deposition aid polymer is a dextran polymer functionalized with quaternary ammonium moieties. More preferably, the deposition aid polymer is a dextran polymer functionalized with quaternary ammonium moieties; wherein the quaternary ammonium moieties are of formula (A) bound to a pendant oxygen on the dextran polymer

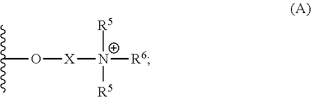

wherein

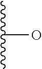 [SMILES: *O]

is a pendant oxygen on the dextran polymer; wherein X is a divalent linking group bonding the quaternary ammonium moiety to the pendent oxygen on the dextran polymer (preferably, wherein X is selected from divalent hydrocarbon groups, which may optionally be substituted (e.g., with a hydroxy group, an alkoxy group, an ether group); more preferably, wherein X is a —CH₂CH(OR⁷)CH₂— group; wherein R⁷ is selected from the group consisting of a hydrogen and a C₁₋₄ alkyl group (preferably, a hydrogen); most preferably, X is a —CH₂CH(OH)CH₂— group); wherein each R⁵ is independently selected from the group consisting of a C₁₋₇ alkyl group (preferably, a C₁₋₃ alkyl group; more preferably, a methyl group and an ethyl group; most preferably, a methyl group); and wherein R⁶ is selected from the group consisting of a C₁₋₂₂ alkyl group (preferably, selected from the group consisting of a C₁₋₃ alkyl group and a C₆₋₂₂ alkyl group; more preferably, a methyl group and an ethyl group; most preferably, a methyl group). Most preferably, the deposition aid polymer is a cationic dextran polymer; wherein the cationic dextran polymer, comprises a dextran polymer functionalized with quaternary ammonium groups; wherein the quaternary ammonium groups are selected from the group consisting of quaternary ammonium moieties of formula (B) bound to a pendent oxygen on the dextran polymer

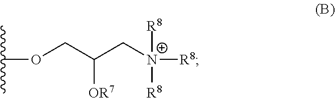

wherein R⁷ is selected from the group consisting of a hydrogen and a C₁₋₄ alkyl group (preferably, a hydrogen); and wherein each R⁸ is independently selected from the group consisting of a methyl group and an ethyl group (preferably, a methyl group).

Preferably, the deposition aid polymer comprises <0.001 meg/gram (preferably, <0.0001 meq/gram; more preferably, <0.00001 meq/gram; most preferably, <detectable limit) of aldehyde functionality.

Preferably, the deposition aid polymer comprises <0.1% (preferably, <0.01%; more preferably, <0.001%; most preferably, <detectable limit), of the linkages between individual glucose units in the deposition aid polymer are β-1,4 linkages.

Preferably, the deposition aid polymer comprises <0.1% (preferably, <0.01%; more preferably, <0.001%; most preferably, <detectable limit), of the linkages between individual glucose units in the deposition aid polymer are β-1,3 linkages.

Preferably, the deposition aid polymer comprises <0.001 meq/gram (preferably, <0.0001 meq/gram; more preferably, <0.00001 meq/gram; most preferably, <detectable limit) of silicone containing functionality.

Preferably, the fabric care composition of the present invention is a laundry detergent.

Preferably, the fabric care composition of the present invention is a laundry detergent. Preferably, the laundry detergent optional comprises additives selected from the group consisting of builders (e.g., sodium citrate), hydrotropes (e.g., ethanol, propylene glycol), enzymes (e.g., protease, lipase, amylase), preservatives, perfumes (e.g., essential oils such as D-limonene), fluorescent whitening agents, dyes, additive polymers and mixtures thereof.

Preferably, the fabric care composition of the present invention further comprises: 0 to 10 wt % (preferably, 1 to 10 wt %; more preferably, 2 to 8 wt %; most preferably, 5 to 7.5 wt %), based on the weight of the fabric care composition, of a hydrotrope. More preferably, the fabric care composition of the present invention further comprises: 0 to 10 wt % (preferably, 1 to 10 wt %; more preferably, 2 to 8 wt %; most preferably, 5 to 7.5 wt %), based on the weight of the fabric care composition, of a hydrotrope; wherein the hydrotrope is selected from the group consisting of alkyl hydroxides; glycols, urea; monoethanolamine; diethanolamine; triethanolamine; calcium, sodium, potassium, ammonium and alkanol ammonium salts of xylene sulfonic acid, toluene sulfonic acid, ethylbenzene sulfonic acid and cumene sulfonic acid; salts thereof and mixtures thereof. Still more preferably, the fabric care composition of the present invention further comprises: 0 to 10 wt % (preferably, 1 to 10 wt %; more preferably, 2 to 8 wt %; most preferably, 5 to 7.5 wt %), based on the weight of the fabric care composition, of a hydrotrope; wherein the hydrotrope is selected from the group consisting of ethanol, propylene glycol, sodium toluene sulfonate, potassium toluene sulfonate, sodium xylene sulfonate, ammonium xylene sulfonate, potassium xylene sulfonate, calcium xylene sulfonate, sodium cumene sulfonate, ammonium cumene sulfonate and mixtures thereof. Yet still more preferably, the fabric care composition of the present invention further comprises: 0 to 10 wt % (preferably, 1 to 10 wt %; more preferably, 2 to 8 wt %; most preferably, 5 to 7.5 wt %), based on the weight of the fabric care composition, of a hydrotrope; wherein the hydrotrope includes at least one of ethanol, propylene glycol and sodium xylene sulfonate. Most preferably, the fabric care composition of the present invention further comprises: 0 to 10 wt % (preferably, 1 to 10 wt %; more preferably, 2 to 8 wt %; most preferably, 5 to 7.5 wt %), based on the weight of the fabric care composition, of a hydrotrope; wherein the hydrotrope is a mixture of ethanol, propylene glycol and sodium xylene sulfonate.

Preferably, the fabric care composition of the present invention further comprises: 0 to 10 wt % (preferably, 0.1 to 10 wt %), based on the weight of the fabric care composition, of a fragrance. More preferably, the fabric care composition of the present invention further comprises: 0 to 10 wt % (preferably, 0.1 to 10 wt %), based on the weight of the fabric care composition, of a fragrance; wherein the fragrance includes an essential oil. Most preferably, the fabric care composition of the present invention further comprises: 0 to 10 wt % (preferably, 0.1 to 10 wt %), based on the weight of the fabric care composition, of a fragrance; wherein the fragrance includes esters (e.g., geranyl acetate); terpenes (e.g., geraniol, citronellol, linalool, limonene) and aromatic compounds (e.g., vanilla, eugenol).

Preferably, the fabric care composition of the present invention further comprises: 0 to 30 wt % (preferably, 0.1 to 15 wt %; more preferably, 1 to 10 wt %), based on the weight of the fabric care composition, of a builder. More preferably, the fabric care composition of the present invention further comprises: 0 to 30 wt % (preferably, 0.1 to 15 wt %; more preferably, 1 to 10 wt %), based on the weight of the fabric care composition, of a builder; wherein the builder is selected from the group consisting of inorganic builders (e.g., tripolyphosphate, pyrophosphate); alkali metal carbonates; borates; bicarbonates; hydroxides; zeolites; citrates (e.g., sodium citrate); polycarboxylates; monocarboxylates; aminotrismethylenephosphonic acid; salts of aminotrismethylenephosphonic acid; hydroxyethanediphosphonic acid; salts of hydroxyethanediphosphonic acid; diethylenetriaminepenta(methylenephosphonic acid); salts of diethylenetriaminepenta(methylenephosphonic acid); ethylenediaminetetraethylene-phosphonic acid; salts of ethylenediaminetetraethylene-phosphonic acid; oligomeric phosphonates; polymeric phosphonates; mixtures thereof. Most preferably, the fabric care composition of the present invention further comprises: 0 to 30 wt % (preferably, 0.1 to 15 wt %; more preferably, 1 to 10 wt %), based on the weight of the fabric care composition, of a builder; wherein the builder includes a citrate (preferably, a sodium citrate).

Preferably, the fabric care composition is in a liquid form having a pH from 6 to 12.5; preferably at least 6.5, preferably at least 7, preferably at least 7.5; preferably no greater than 12.25, preferably no greater than 12, preferably no greater than 11.5. Suitable bases to adjust the pH of the formulation include mineral bases such as sodium hydroxide (including soda ash) and potassium hydroxide; sodium bicarbonate, sodium silicate, ammonium hydroxide; and organic bases such as mono-, di- or tri-ethanolamine; or 2-dimethylamino-2-methyl-1-propanol (DMAMP). Mixtures of bases may be used. Suitable acids to adjust the pH of the aqueous medium include mineral acid such as hydrochloric acid, phosphorus acid, and sulfuric acid; and organic acids such as acetic acid. Mixtures of acids may be used. The formulation may be adjusted to a higher pH with base and then back titrated to the ranges described above with acid.

The present invention provides a method of treating an article of laundry, comprising: providing an article of laundry; providing a fabric care composition of the present invention; providing a bath water; and applying the bath water and the fabric care composition to the article of laundry to provide a treated article of laundry; wherein the fabric care benefit agent is associated with the treated article of laundry (preferably, wherein the fabric care benefit agent is not covalently bonded to the treated article of laundry). More preferably, the present invention provides a method of treating an article of laundry, comprising: providing an article of laundry; providing a fabric care composition of the present invention; providing a bath water; and applying the bath water and the fabric care composition to the article of laundry to provide a treated article of laundry; wherein the fabric care benefit agent is associated with the treated article of laundry (preferably, wherein the fabric care benefit agent is not covalently bonded to the treated article of laundry) and wherein the deposition aid polymer improves the laundry delivery efficacy of the fabric care benefit agent (preferably, wherein the fabric care benefit agent is a fabric softening silicone).

Some embodiments of the present invention will now be described in detail in the following Examples.

The modified carbohydrate polymers in the Examples were characterized as follows.

The volatiles and ash content (measured as sodium chloride) were determined as described in ASTM method D-2364.

The total Kjeldahl nitrogen content (TKN) was determined in duplicate using a Buchi KjelMaster K-375 automatic Kjeldahl analyzer. The TKN values were corrected for volatiles and ash.

### Example S1: Synthesis of Branched Chain Cationic Dextran Polymer

A 500 ml, four-necked, round-bottomed flask was charged with dextran (40.25 g; Ultradex 531 dextran powder) and deionized water (89.58 g). The flask was fitted with a stirring paddle and electric motor. The mixture was stirred until the dextran was completely dissolved, approximately 40 minutes. After the dextran was dissolved, a 70% aqueous solution of 2,3-epoxypropyltrimethylammonium chloride (27.13 g; QUAB® 151 available from SKW QUAB Chemicals) was added to the mixture. The flask was fitted with a nitrogen inlet, a rubber serum cap, and a Claisen adaptor connected to a subsurface thermocouple connected to a J-KEM controller, and a Friedrich condenser connected to a mineral oil bubbler. The mixture was then stirred under nitrogen for one hour to remove any entrained oxygen in the system. After the one-hour nitrogen purge was completed a 25% aqueous sodium hydroxide solution (6.35 g) was added and heat was applied to the reaction mixture using a J-KEM controller and heating mantle. The heating set-point was adjusted to 70° C. When the reaction mixture reached 70° C., the timer was started, and the reaction mixture was allowed to react for four hours under nitrogen.

After four hours at 70° C., the reaction mixture was cooled in a water bath while maintaining a positive nitrogen pressure in the flask. The reaction mixture was neutralized by adding glacial acetic acid (2.5 g) using a syringe and allowing the mixture to stir for 10 minutes. A 50 ml portion of the cationic dextran solution was retained as a solution for rheological characterization, and 1% EUXYL PE 9010 preservative was added to the retained solution. The balance of the polymer was then recovered from the aqueous solution by non-solvent precipitation from methanol. A Waring blender was charged with 700 ml of methanol and approximately 20 ml of polymer solution was slowly and continuously added at a moderate mixing speed. High speed mixing results in unwanted peptization of the polymer precipitate. At the onset of opacification of the methanol non-solvent, the precipitated polymer was recovered by filtration through a set of nested #40 and #80 US standard sieve screens. The Waring blender was charged with fresh methanol and the non-solvent precipitation of the remaining aqueous solution was continued. The polymer was briefly air dried, then dried overnight in vacuo at 50° C. The dried polymer was manually ground with a mortar and pestle and screened through a US standard #30 sieve. A white solid was obtained (43.13 g), with a volatiles content of 4.04%, an ash content (as sodium chloride) of 0.85% (measured as described in ASTM method D-2364), and using a Buchi KjelMaster K-375 automated analyze the Kjeldahl nitrogen content of the product polymer was measured to be 1.71% (corrected for volatiles and ash), corresponding to a CS value of 0.243.

### Comparative Examples CF1-CF3 and Examples F1: Fabric Care Composition

Fabric care compositions were prepared in each of Comparative Examples CF1-CF3 and Example F1 having the formulation as described in TABLE 1 and prepared by standard laundry formulation preparation procedure.

TABLE 1

| | CF1 | CF2 | CF3 | F1 |
|---|---|---|---|---|
| Ingredient | wt % | | | |
| Linear alkyl benzene sulfonate¹ | 8.0 | 8.0 | 7.8 | 7.8 |
| Sodium lauryl ethoxysulfate² | 6.0 | 6.0 | 5.9 | 5.9 |
| Propylene glycol | 5.0 | 5.0 | 4.9 | 4.9 |
| Ethanol | 2.0 | 2.0 | 1.9 | 1.9 |
| Nonionic alcohol ethoxylate³ | 6.0 | 6.0 | 5.9 | 5.9 |
| Sodium citrate | 5.0 | 5.0 | 4.9 | 4.9 |
| Example S1 | — | — | 1.0 | 1.0 |
| Silicone fluid⁴ | — | 2.0 | — | 1.9 |
| Deionized water | 68 | 66 | 67.7 | 65.8 |

| | |
|---|---|
| NaOH (10% solution) | Adjust pH to 8.0 |

¹Nacconol 90G available from Stepan Company
²Steol CS-460 available from Stepan Company
³Biosoft N25-7 available from Stepan Company
⁴XIAMETER ™ OFX-8505 available from The Dow Chemical Company

### Silicone In-Wash Deposition

The silicone in wash deposition of the silicone containing fabric care compositions was evaluated for each of the compositions of Comparative Examples CF1-CF3 and Examples F1 on cotton. Speed Queen TR7 (Model number AWNE9RSN116TW01) top loading washing machines were used for the evaluations. Four Kohl's The Big One® washcloths (100% cotton) were used in each washing machine. All Kohl's cloths were stripped prior to use in these laundry evaluations to remove any treatments applied during manufacturing. Washes were carried out using the heavy-duty cycle with light soil level and the medium load size (˜59 L). The temperature was set to cold/cold and the water temperature adjusted to 70° F. The water was hardened to 150 ppm with a 2:1 Ca²⁺:Mg²⁺ mole ratio. The detergent dosage used was 0.5 gdetergent/Liter of water. After three machine cycles were completed, the cloths were tumble dried in an industrial dryer on the high heat setting until dry. Additional ballast was added to the dryers to equal six pounds. After dry, the cloths were hung in a constant temperature and humidity chamber to condition for 24 hours at 21° C. and 65% relative humidity. After the cloths were conditioned, they were tested using the PhabrOmeter® Model 3 10 kg instrument to evaluate the softness. The results are provided in TABLE 2.

TABLE 2

| Formulation Example | Average Softness Score |
|---|---|
| CF1 | 77.93 |
| CF2 | 77.63 |
| CF3 | 77.89 |
| F1 | 78.74 |

### Prophetic Soil Anti-Redeposition Testing

The soil anti-redeposition of the fabric care compositions is evaluated for each of the compositions of Comparative Examples CF1-CF3 and Example F1 on four types of fabric (cotton interlock, cotton, polyester/cotton blend, cotton terry) by washing the fabrics in a Terg-O-tometer under typical washing conditions (ambient wash temperature, water hardness: 200 ppm Ca²⁺:Mg²⁺ of 3:1 mole ratio, with a 60 minute wash and a 3 minute rinse, 1 L/wash) using a detergent dosage of 0.5 g/L. An orange (high iron content) clay slurry (0.63 g Red Art Clay) and dust sebum dispersion (2.5 g) is the added soil load. Once washing is complete, the fabric swatches are dried, and read on a Mach5 color instrument to compute the Whiteness Index (WI) in accordance with ASTM E313. From the results the fabric care composition of Example F1 is shown to exhibit desirable anti-redeposition performance relative to the comparative formulations.

We claim:

1. A fabric care composition comprising:
water;
a cleaning surfactant;
a fabric softening silicone, wherein the fabric softening silicone is a nitrogen containing silicone; and
a deposition aid polymer, wherein the deposition aid polymer is a dextran polymer functionalized with quaternary ammonium moieties; and
wherein the deposition aid polymer enhances deposition of the fabric softening silicone from the fabric care composition onto a fabric.

2. The fabric care composition of claim 1, wherein the deposition aid polymer has a Kjeldahl nitrogen content corrected for ash and volatiles of 0.5 to 5.0 wt %.

3. The fabric care composition of claim 2, wherein the deposition aid polymer is a branched chain dextran polymer functionalized with quaternary ammonium groups.

4. The fabric care composition of claim 3, wherein the branched chain dextran polymer comprises a plurality of glucose structural units; wherein 90 to 98 mol % of the glucose structural units are connected by α-D-1,6 linkages and 2 to 10 mol % of the glucose structural units are connected by α-1,3 linkages.

5. The fabric care composition of claim 4, wherein the fabric care composition is a laundry detergent.

6. The laundry detergent of claim 5, wherein the cleaning surfactant is selected from the group consisting of anionic surfactants, nonionic surfactants, cationic surfactants, amphoteric surfactants and mixtures thereof.

7. The laundry detergent of claim 6, wherein the cleaning surfactant includes a mixture of a linear alkyl benzene sulfonate, a sodium lauryl ethoxysulfate and a nonionic alcohol ethoxylate.

8. The laundry detergent of claim 7, wherein the nitrogen containing silicone contains 0.1 to 2 wt % nitrogen.

9. A method of treating an article of laundry, comprising: providing an article of laundry; selecting a fabric care composition according to claim 1; providing a bath water; and applying the bath water and the fabric care composition to the article of laundry to provide a treated article of laundry; wherein the fabric softening silicone is associated with the treated article of laundry.

10. The method of claim 9, wherein the fabric care composition is according to claim 8.
